(19) United States
(12) Patent Application Publication
(10) Pub. No.: US 2010/0020134 A1
(43) Pub. Date: Jan. 28, 2010

(54) INK-JET HEAD

(75) Inventors: Won-Chul SIM, Seongnam-si (KR); Jae-Woo Joung, Suwon-si (KR); Chang-Sung Park, Suwon-si (KR); Suk-Ho Song, Ansan-si (KR); Young-Seuck Yoo, Seoul (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 12/424,194

(22) Filed: Apr. 15, 2009

(30) Foreign Application Priority Data
Jul. 28, 2008 (KR) 10-2008-0073396

(51) Int. Cl. B41J 2/045

(52) U.S. Cl. 347/71

(57) ABSTRACT

An ink-jet head is disclosed. The ink-jet head in accordance with an embodiment of the present invention includes: a body, a plurality of chambers, which are formed inside the body such that the plurality of chamber accommodate ink, a plurality of actuators, which are coupled to one side of the body such that pressure is supplied to each of the plurality of chambers, a holding groove, which is formed on one side of the body, and a common electrode, which is interposed between the actuators and the body and in which a part of the common electrode is formed on in the holding groove such that the plurality of actuators are electrically connected to one another. The ink-jet head can prevent defective signal transduction of an actuator and crosstalk between chambers.

### CROSS-REFERENCE TO RELATED APPLICATIONS

This application claims the benefit of Korean Patent Application No. 10-2008-0073396, filed with the Korean Intellectual Property Office on Jul. 28, 2008, the disclosure of which is incorporated herein by reference in its entirety.

### BACKGROUND

1. Technical Field

The present invention relates to an ink-jet head.

2. Description of the Related Art

An ink-jet head is an apparatus for ejecting droplets through a nozzle by transforming electric signals to physical forces. FIG. 1 is a side cross-sectional view illustrating a process of manufacturing an ink-jet head according to the related art. As illustrated in FIG. 1, in order to manufacture an ink-jet head 100, a common electrode 14 may be formed on a membrane 20, and then a piezoelectric element 10 may be attached to the common electrode 14. After that, the piezoelectric element 10 may be divided into piezoelectric elements 11 and 12 through a dicing process using a cutter 18.

When forming a body 5 by attaching a silicon wafer, the dicing process may be performed at temperatures above 1,000 degrees Celsius so that the body 5 may be bent, and thus the precision of a dicing process has been inevitably restricted.

In case the piezoelectric element 10 is diced in the same thickness in the dicing process, the limitations of controlling the precision of a dicing process causes a problem of severing the membrane 20 as well as the common electrode 14. If the common electrode 14 is severed, electrical signal is not transferred to the piezoelectric element 10 smoothly, causing the deterioration of the print quality.

FIG. 2 is a front cross-sectional view illustrating an ink-jet head according to the related art. As illustrated in FIG. 2, if the piezoelectric elements 11 and 12 are severed to the depth that is less than the thickness thereof, the common electrode 14 may not be divided, but the piezoelectric elements 11 and 12 may not be completely divided as well. If the first piezoelectric element 11 is activated, the second piezoelectric element 12 may be vibrated, causing an unstable meniscus movement and thus deteriorating the printing quality.

### SUMMARY

The present invention provides an ink-jet head for preventing defective signal transduction of an actuator and crosstalk between chambers.

An aspect of the present invention provides an ink-jet head. The ink-jet head in accordance with an embodiment of the present invention includes: a body, a plurality of chambers, which are formed inside the body such that the plurality of chamber accommodate ink, a plurality of actuators, which are coupled to one side of the body such that pressure is supplied to each of the plurality of chambers, a holding groove, which is formed on one side of the body, and a common electrode, which is interposed between the actuators and the body and in which a part of the common electrode is formed on in the holding groove such that the plurality of actuators are electrically connected to one another.

Here, the plurality of actuators are arranged in a line, and the holding groove can be extended along the line of the plurality of actuators.

The common electrode can include: a plurality of access portions, in which each of the plurality of access portions is coupled to each of the plurality of actuators, respectively, and a connection part, which is formed on an inner surface of the holding groove such that the plurality of access portions are electrically connected to one another.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a side cross-sectional view illustrating a process of manufacturing an ink-jet head according to the related art.

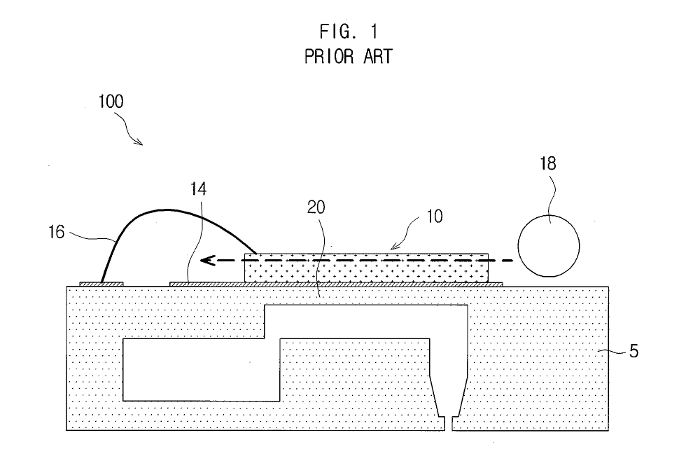

FIG. 2 is a front cross-sectional view illustrating an ink-jet head according to the related art.

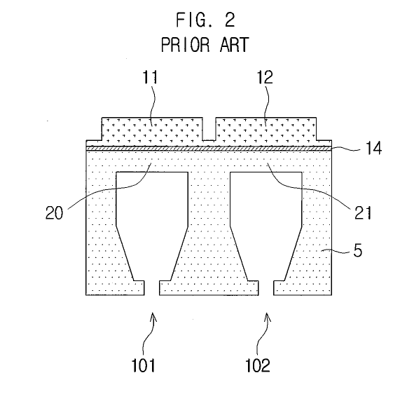

FIG. 3 is a side cross-sectional view illustrating a process of manufacturing an ink-jet head according to an embodiment of the present invention.

FIG. 4 is a plan view illustrating an ink-jet head according to an embodiment of the present invention.

FIG. 5 is a perspective view illustrating a part of a common electrode of an ink-jet head according to an embodiment of the present invention.

FIG. 6 is a front cross-sectional view illustrating an ink-jet head according to an embodiment of the present invention.

### DETAILED DESCRIPTION

The features and advantages of this invention will become apparent through the below drawings and description.

An ink-jet head according to certain embodiments of the present invention will be described below in more detail with reference to the accompanying drawings. Those components that are the same or are in correspondence are rendered the same reference numeral regardless of the figure number, and redundant explanations are omitted.

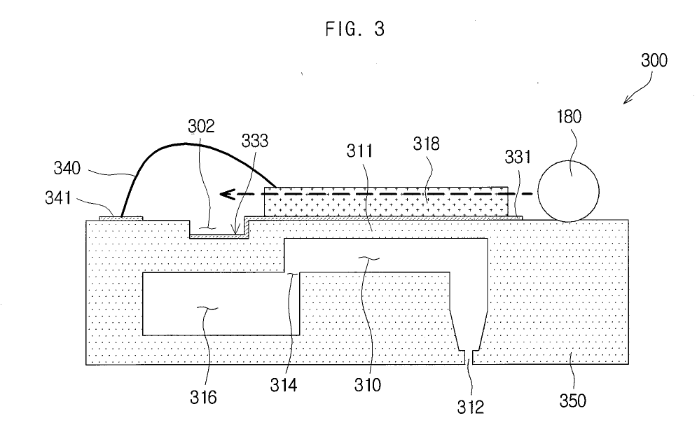

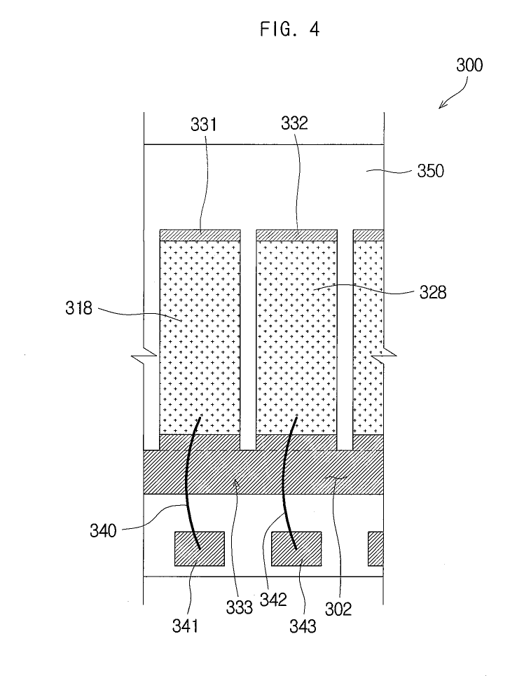

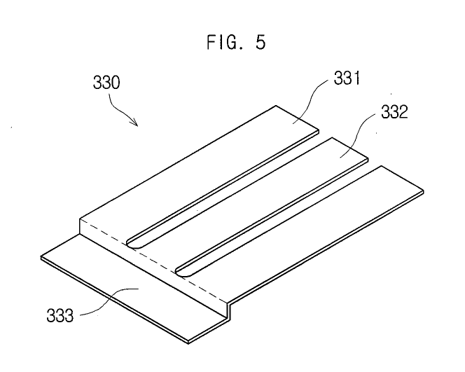

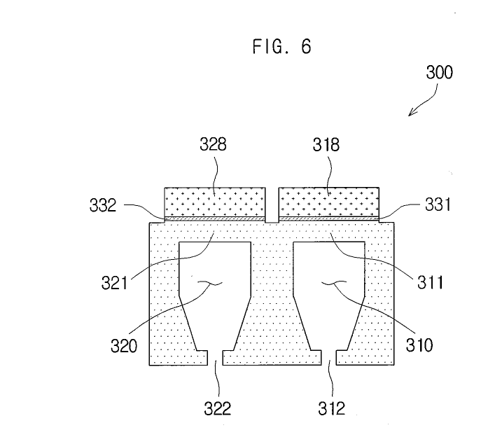

FIG. 3 is a side cross-sectional view illustrating a process of manufacturing an inkjet head according to an embodiment of the present invention, and FIG. 4 is a plan view illustrating an ink-jet head according to an embodiment of the present invention. FIG. 5 is a perspective view illustrating a part of a common electrode of an ink-jet head according to an embodiment of the present invention, and FIG. 6 is a front cross-sectional view illustrating an ink-jet head according to an embodiment of the present invention.

Referring to FIG. 3, the basic structure of the ink-jet head can be represented as follows.

A reservoir 316 contains ink and provides the ink to a chamber 310 through a restrictor 314, which will be described later. The reservoir 316 can be supplied with the ink from outside through an inlet (not illustrated).

The restrictor 314 links the reservoir 316 with the chamber 310, which will be described later, and can function as a channel supplying the ink to the chamber 310 from the reservoir 316. The restrictor 314 is formed to have a smaller sectional area than that of the reservoir 316 such that the restrictor 314 can control the amount of ink supplied to the chamber 310 from the reservoir 316 when pressure is applied on the chamber 310 by an actuator.

The chamber 310 is linked with the reservoir 316 by being connected to the restrictor 314. The chamber 310 can be more than one, and a plurality of chambers 310 can be lined up. Also, a nozzle 312 is connected on an opposite side of where the chamber 310 is connected to the restrictor 314. Through such a structure, an ink-jet head 300 can perform the printing by being supplied with the ink from the reservoir 316, holding the ink, and supplying the ink to the nozzle 312.

One side of the chamber 310 can be covered by a membrane 311, and the actuator can be coupled to an upper surface of the membrane 311 corresponding to the location of the chamber 310. A piezoelectric component 318, for example, can be used as the actuator.

The piezoelectric component 318 can generate vibrations, when electricity is supplied, by being coupled to the upper surface of the membrane 311 corresponding to the location of the chamber 310. The piezoelectric component 318 can supply pressure to the chamber 310 through the membrane 311, by generating the vibration according to the voltage supplied to the piezoelectric component 318.

The nozzle is 312 connected to the chamber 310 such that the ink can be supplied from the chamber 310 and ejected. When the vibration generated through the piezoelectric component 318 is supplied to the chamber 310, pressure can be applied on the chamber 310, and thus the ink can be ejected through the nozzle 312 by the pressure.

The ink-jet head 300 according to an embodiment of the present invention has a body 350, a plurality of chambers 310 and 320, which are formed inside the body 350 to hold the ink, a plurality of actuators 318 and 328, which are coupled to either side of the body to supply pressure to either of the plurality of chambers 310 and 320, a holding groove 302 formed on one side of the body 350, and a common electrode 330, which is interposed between the actuators 318 and 328 and one side of the body 350 and a part of which is formed inside the holding groove 302 such that the plurality of actuators 318 and 328 are electrically connected. The ink-jet head 300 can prevent crosstalk between the actuators 318 and 328 and the adjacent chambers 310 and 320, thereby improving the printing quality.

The body 350, which constitutes the main body of the ink-jet head, can be formed by stacking a plurality of silicon wafers. The reservoir 316, the restrictor 314, the chamber 310, and the nozzle 312, which have been described above, can be formed inside the body 350. One side of the body 350, to which the piezoelectric component 318 is coupled, can be the upper surface of the membrane 311, which is described above.

As illustrated in FIGS. 3 and 4, the holding groove 302 can be formed on one side of the body 350. If the plurality of piezoelectric components 318 and 328 are arranged in a line on one side of the body 350, the holding groove 302 can be extended along the line of arrangement of the plurality of piezoelectric components 318 and 328. The holding grove 302 can be formed by way of, for example, wet-etching on one side of the silicon wafers constituting one side of the body 350.

The holding groove 302 holds a connection part 333, which is a part of the common electrode 330 described below and prevents the common electrode 330 from being separated during a dicing process. The depth formed in the holding groove 302 can be deeper than the depth by which the body 350 is severed by a cutting machine 180 in the dicing process.

Individual electrodes 340 and 342, which individually transmit an electrical signal, can be attached to the piezoelectric components 318 and 328, and can be attached on individual electrode pads 341 and 343, which are formed on one side of the body 350. The vibration can be generated independently on the piezoelectric components 318 and 328 by the individual electrodes 340 and 342.

The common electrode 330 is interposed between the piezoelectric components 318 and 328 and the body 350, and a part of the common electrode 330 can be formed inside the holding groove 302 to electrically connect the plurality of piezoelectric components 318 and 328 to each other.

The common electrode 330 can be formed to have a step on one side of the body and on an inner surface of the holding groove 302 by a vacuum plating, such as on one side of the body 350, in which the holding groove 302 is formed.

After the common electrode 330 is formed, the piezoelectric components can be coupled onto the common electrode 330. Then, access portions 331, 332 of the common electrode 330 and each of the piezoelectric components 318 and 328 can be formed through the dicing process.

As illustrated in FIG. 5, the common electrode 330 can have a plurality of access portions 331 and 332, which are coupled to the plurality of piezoelectric components 318 and 328, respectively, and the connection part 333, which is formed on the inner surface of the holding groove 302 such that the plurality of access portions 331 and 332 can be electrically connected.

As illustrated in FIGS. 3 and 5, the access portions 331 and 332 can be formed separately from each other through the dicing process, and coupled to the piezoelectric components 318 and 328, respectively. Conversely, the connection part 333 is formed on the inner surface of the holding groove 302 such that the connection part 333 is positioned deeper than where the body 350 is severed in the dicing process, and thus the connection part 333 is not severed in the dicing process. Therefore, the connection part 333 can provide the electrical connection between the plurality of access portions 331 and 332 after the dicing process.

As illustrated in FIGS. 3 and 6, the piezoelectric components 318 and 328 are completely separated after the dicing process. Also, the access portions 331 and 332 of the common electrode 330 are completely separated. However, a first piezoelectric component 318 and a second piezoelectric component 332 are electrically connected to each other through the connection part 333 of the common electrode 330.

According to this embodiment, therefore, the ink-jet head 300 does not sever the common electrode 330 due to a dicing error, which can occur in the dicing process, and thus can maintain the electrical connection between the piezoelectric components while solving the problems of defective signal transduction and crosstalk by physically severing the piezoelectric components 318 and 328 from each other.

According to an embodiment of the present invention as set forth above, the ink-jet head can improve the printing quality by preventing the crosstalk between adjacent chambers as well as defective signal transduction due to a severed common electrode caused by an error in the dicing process.

While the spirit of the invention has been described in detail with reference to particular embodiments, the embodiments are for illustrative purposes only and do not limit the invention. It is to be appreciated that those skilled in the art can change or modify the embodiments without departing from the scope and spirit of the invention. As such, many embodiments other than those set forth above can be found in the appended claims.

What is claimed is:

1. An ink-jet head comprising:
a body;
a plurality of chambers formed inside the body such that the plurality of chamber accommodate ink;
a plurality of actuators coupled to one side of the body such that pressure is supplied to each of the plurality of chambers;
a holding groove formed on one side of the body; and
a common electrode interposed between the actuators and the body, a part of the common electrode being formed on in the holding groove such that the plurality of actuators are electrically connected to one another.

2. The ink-jet head of claim 1, wherein the plurality of actuators are arranged in a line, and the holding groove is extended along the line of the plurality of actuators.

3. The ink-jet head of claim 1, wherein the common electrode comprises:
a plurality of access portions, each of the plurality of access portions being coupled to each of the plurality of actuators, respectively; and
a connection part formed on an inner surface of the holding groove such that the plurality of access portions are electrically connected to one another.
